(19) United States
(12) Patent Application Publication
(10) Pub. No.: US 2014/0189488 A1
(43) Pub. Date: Jul. 3, 2014

(54) METHOD AND APPARATUS FOR INFORMATION COMPRESSION IN A WIRELESS NETWORK

(71) Applicant: MOTOROLA SOLUTIONS, INC., SCHAUMBURG, IL (US)

(72) Inventors: Satyanarayana Tummalapenta, Karnataka (IN); Anees Abdulkader Anakkot, Kerala (IN); Tyrone D. Beklares, Chicago, IL (US)

(73) Assignee: MOTOROLA SOLUTIONS, INC., SCHAUMBURG, IL (US)

(21) Appl. No.: 13/729,321

(22) Filed: Dec. 28, 2012

(51) Int. Cl. G06F 17/21

(52) U.S. Cl. CPC G06F 17/218
USPC 715/234

(57) ABSTRACT

A method (200) and a user terminal associated with a presentity (410) compress presence information in an XML format presence document, for wireless transmission in a wireless communication system. A dictionary-based compression is applied (220) to a first portion of the presence document, the first portion of the presence document comprising at least one item of uncompressible information. A non-dictionary-based, structured information representation method is applied (230) to a second portion of the presence document. The non-dictionary-based, structured information representation method may be ASN-1 encoding. The at least one item of uncompressible information may comprise a dynamic entity. The second portion of the presence document may comprise tags, enumerated strings, and/or XML fields. Each watcher (430) may receive and store an individual dictionary for each presentity (410) that it watches.

### FIELD OF THE DISCLOSURE

The present disclosure relates generally to the compression of presence information for transmission in a wireless communications network.

### BACKGROUND

Wireless communication devices may provide information about their location, status and/or availability to other wireless communication devices, as ‘presence information’. Presence may be defined as the ability of a person or device to communicate with others and to display levels of availability.

A ‘presentity’ is an entity that provides presence information to other entities, such as persons, devices or services. A ‘watcher’ is an entity that requests presence information about a presentity, from a presence service. A ‘presence server’ is a software platform that gathers presence information from multiple providers (presentities). The presence server shares the presence information between the providers and any other applications that are interested in the presence information, i.e. watchers.

A watcher creates a ‘subscription’ with the presence server when it wishes to view the presence of a presentity. A watcher can create a subscription for individual presentities, or for a group of presentities. A subscription for a group of presentities may also be called a ‘resource list’. In many presence systems, a watcher creates resource lists and adds onto these lists all the presentities that it intends to watch. Subscriptions are made to these lists, instead of making individual subscriptions.

When the server receives a presence update (as a ‘PUBLISH’ message) from a presentity, it forwards that update (as a ‘NOTIFY’ message) to various watchers. Those watchers are the watchers who have subscribed (with a ‘SUBSCRIBE’ message) to the presence of that presentity. A watcher usually has a combination of individual and group subscriptions, depending on the type of presentities it is watching.

The presence documents that contain the presence info are usually in an XML format, called ‘Presence Information Data Format’ or simply PIDF. Since the presence documents are in Extensible Mark-up Language (XML) format, they tend to be large in size. The size of these presence documents may make them too large to send using the most efficient transmission protocols. Due to their size, the presence documents may need to be sent over Transmission Control Protocol (TCP), which is undesirable due to the nature of the TCP protocol.

Known communications systems use dictionary-based compression schemes like the ‘Presence-Specific Static Dictionary for Signalling Compression’ (SIGCOMP) standard to compress some documents. However, known dictionary-based compression schemes are computationally intensive, due to their high complexity. They therefore lead to high Central Processing Unit (CPU) utilization. For these reasons, dictionary-based compression schemes are unsuitable in a server which handles a very large number of presentity events per second.

FIG. 1 shows an illustration of a system that would result from applying a dictionary-based compression scheme such as SIGCOMP to presence documents from two presentities.

Communication system 100 comprises a first presentity 110. First presentity 110 produces a first dictionary P1, when compressing a presence document that presentity 110 creates. First presentity 110 forwards first dictionary P1 to presence server 120 as a PUBLISH event. Presence server 120 serves both to decompress and compress the first dictionary P1. A second presentity 170 produces a second dictionary P2, when compressing a presence document that presentity 170 creates. Second presentity 170 forwards second dictionary P2 to presence server 120 as a PUBLISH event. Presence server 120 decompresses the first dictionary P1 and the second dictionary P2.

Presence server 120 combines first dictionary P1 and second dictionary P2 to create a dictionary W1 for a first watcher 130, and a dictionary W2 for a second watcher 140. Dictionary W1 also contains dictionaries provided by other presentities on the watch list of first watcher 130. Dictionary W2 also contains dictionaries provided by other presentities on the watch list of second watcher 140. Presence server 120 forwards dictionary W1 to first watcher 130 and dictionary W2 to second watcher 140. First watcher 130 stores the dictionary W1, as shown at 150. Second watcher 140 stores the dictionary W2, as shown at 160.

Whenever a new presence document is provided to presence server 120 from another presentity, the dictionaries W1 and/or W2 need to be updated, if either first watcher 130 or second watcher 140 is a subscriber to the presentity providing the new presence document. Presence server 120 therefore carries out significant amounts of compression and decompression. There is also a significant transmission load in re-forwarding dictionaries W1 and W2 to first watcher 130 and second watcher 140. Presence server 120 will store one dictionary, such as W1 or W2, which is a ‘bespoke’ dictionary for each watcher. Each of dictionaries W1 and W2 is a ‘bespoke’ dictionary for an individual watcher.

When dictionaries P1 and P2 in FIG. 1 are compiled using the SIGCOMP standard, the resulting dictionaries have an entry for each character string in each presence document. The dictionaries P1, P2, W1 and W2 would become very large, and each would have a dynamic subsection and a static sub-section within it. Each time the presentity tries to find an index in the dictionary for the next word in a presence document, it has to search the very large number of entries accumulated in the dictionary P1 or P2. This is time consuming. Forwarding such large dictionaries P1 and P2 to the presence server and forwarding the resulting bespoke dictionaries W1 and W2 to each watcher requires significant transmission bandwidth. Decompression of each dictionary by the presence server, and re-compression before sending the dictionary to each watcher, is also computationally intensive.

There have been proposals in academic literature about using Abstract Syntax Notation (ASN) ‘ASN-1’ encoding for compressing XML. However, the compression performance of ASN-1 degrades significantly when it encounters large dynamic strings in an XML document. Dynamic strings are the strings that are not defined (or ‘enumerated’) as part of the XML schema. The presentities of many systems tend to have large names and Uniform Resource Locators (URLs), which are uncompressible through ASN-1. An example of such presentities is the users, devices and sub-devices of a wireless video communications system. The compressed presence documents generated in such a system remain large enough that it is necessary to use TCP for transmission. This situation is due to the presence of a large number of uncompressible strings (e.g., camera name) in such presence documents, even after ASN-1 compression.

Accordingly, there is a need for a method and apparatus for compressing information in a wireless network.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows an illustration of a communications system that would result from applying a known dictionary-based compression scheme to presence documents from two presentities.

FIG. 2 is a flowchart of a method of compressing presence information in accordance with some embodiments.

FIG. 3 is a flowchart of a method of compressing presence information in accordance with some embodiments.

FIG. 4 shows an illustration of a communications system with two presentities in accordance with some embodiments.

FIG. 5 illustrates the arrangement of a presentity and the storage of dictionaries in accordance with some embodiments.

FIG. 6 shows a communication system in accordance with some embodiments.

FIGS. 7A, 7B, 7C, 8A, 8B, 8C, and 8D show documents that may be created, in a non-limiting example of an application of the method of some embodiments.

FIG. 9 shows a message sequence chart for signaling employed by some embodiments.

FIG. 10 shows a message sequence chart for signaling employed by some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method of compressing presence information in a presence document for wireless transmission is provided. A presentity in a wireless communications system creates a presence document in XML format, and applies a dictionary-based compression to a first portion of the presence document, the first portion of the presence document comprising at least one item of uncompressible information. The presentity applies a non-dictionary-based, structured information representation to a second portion of the presence document. The at least one item of uncompressible information may comprise an unenumerated character string, and may be a dynamic entity. The at least one item of uncompressible information may comprise one or more of: user names; URLs; device names; dates and IP addresses. The non-dictionary-based, structured information representation may be ASN-1 encoding. The second portion of the presence document may comprise one or more of tags, enumerated strings, and XML fields.

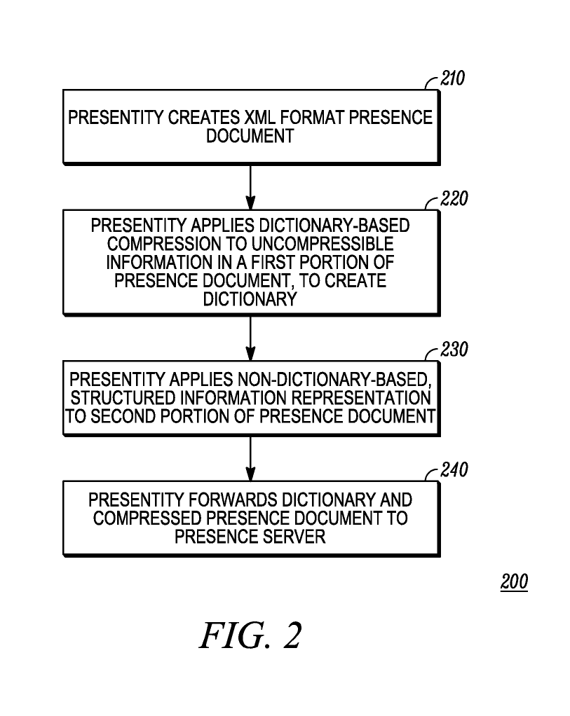

FIG. 2 is a flowchart of a method 200 of compressing presence information in accordance with some embodiments.

At 210, a presentity creates an XML format presence document, which is to be transmitted to a presence server with a PUBLISH message. At 220, the presentity applies dictionary-based compression to uncompressible information in the presence document. The uncompressible information can be considered to constitute a first portion of presence document. However, the uncompressible information will often be distributed throughout the presence document. So the ‘first portion’ of the document may be considered to be some or all of the various parts of the presence document that contain uncompressible information. If, in a non-limiting numerical example, 30% of the presence document comprises uncompressible information, then the first portion is some or all of this 30% of the presence document. The dictionary-based compression leads to the creation of a dictionary.

At 230, the presentity applies a non-dictionary-based, structured information representation method to a second portion of the presence document. The second portion of the presence document is some or all of the part of the presence document that does not contain dynamic strings. So the ‘second portion’ of the document may be considered to be some or all of the various parts of the presence document that contain compressible information. If, in the non-limiting numerical example given above, 70% of the presence document comprises compressible information, then the second portion is some or all of this 70% of the presence document.

In one embodiment, the presentity applies the dictionary-based compression to all the uncompressible information in the presence document, and applies the non-dictionary based, structured information representation to all the compressible information.

At 240, the presentity forwards both the dictionary and the compressed presence document to the presence server. The dictionary and the compressed presence document may be forwarded to the presence server as part of a PUBLISH message sent to the presence server. In a non-limiting numerical example, a typical presence document may be compressed to a size of 1500 bytes or less using the method of FIG. 2, which facilitates transmission of the presence document using UDP protocol. Hence the method of FIG. 2 may, in comparison to known methods, allow transmission with UDP protocol, rather than TCP protocol, of a greater number of all the various presence documents produced by any given presentity.

In step 220 of FIG. 2, the presentity may create a dictionary of indices, wherein each index corresponds to an item of uncompressible information in the first portion of the presence document. The dictionary contains the index, together with the item of uncompressible information that is represented by that index. The presentity can then replace an item of uncompressible information in the first portion of the presence document by the corresponding index from the dictionary of indices.

The method of FIG. 2 takes advantage of the selective use of a structured information representation method, which is possible as XML is a structured notation, unlike free-flowing English text. The structured information representation method used at 230 for compressing the second portion of the XML presence document is also computationally much less burdensome than dictionary-based compression techniques used for compressing text, such as in the first portion of the XML presence document. If ASN-1 is used as the structured information representation method, then, for typical presence documents, it may be between 5 and 22 times more efficient than pure dictionary based compression techniques, with respect to CPU utilization.

The method of FIG. 2 may be considered to be a hybrid compression scheme based on a hybrid of ASN-1 and dynamic dictionary based compression. ASN-1 is used to compress the tags and enumerated XML fields, and numerals and other structured items such as date/time etc. However, dictionary-based compression is used to compress unenumerated text strings, by replacing them with dictionary indices. The presentity may then transmit the dictionary of indices to a presence server, as shown at 240.

In some embodiments, the presentity may wait for an acknowledgment from a receiving party that the dictionary of indices has been received, before replacing the item of uncompressible information in the first portion of the presence document by the corresponding index from the dictionary of indices. Here the receiving party may be a watcher. The watcher may transmit the acknowledgement of receipt of the dictionary of indices back to the presentity via the presence server.

When the presentity creates a new presence document, it may contain one or more dynamic strings for which there is no entry in an existing dictionary, which was created by the presentity for an earlier document. The presentity may then just create an updated entry for the dictionary of indices. The updated entry may comprise a new index, corresponding to the new item of uncompressible information in the new presence document. However, the updated entry may instead just comprise an update of an existing index in the dictionary of indices, rather than an entirely new entry. The presence server may then transmit the updated entry to the receiving party. After transmitting the updated entry for the dictionary of indices to the receiving party, the presentity may wait for an acknowledgment from the receiving party that the updated entry has been received, before using the new index or the updated index, to replace an item of uncompressible information in the first portion of the presence document.

The updated entries, i.e. new entries and/or updates to existing entries, may be incorporated into the XML presence document, and communicated as part of XML presence document itself. However, these dictionary updates may not be used in compression until after the remote party confirms the receipt of these updates with an acknowledgement.

The presence document may be in the Presence Information Data Format of XML. The presentity may use the entity reference mechanism of the XML standard to indicate the dictionary indices in the presence document. The entity reference mechanisms allows an element of an XML document to refer to another element of the same XML document (i.e., internal reference), or another element of a different XML document (i.e., external reference). Both the internal and external entity reference mechanisms of the XML standard may be used, and in each case the dictionary indices will be transmitted within the presence document.

Step 220 of FIG. 2 has thus far been described as involving a presentity creating a dictionary of indices. Each index in the dictionary is stored together with the dynamic string that it indexes. However, some embodiments may also have a ‘static’ dictionary available at the presentity, the presence server and a watcher, with the same static dictionary held by each. Such a static dictionary may be termed a ‘public’ dictionary. If such a static dictionary is available, then the presentity can use pre-existing indices from this static dictionary. The presentity then only needs to create an index in the dynamic dictionary, if the string that the presentity is considering is not already in the static dictionary. This approach may provide smaller individual ‘bespoke’ dictionaries. However, there is a need to ensure that the static dictionaries do have the same entries in each of the presentity, the presence server and each watcher.

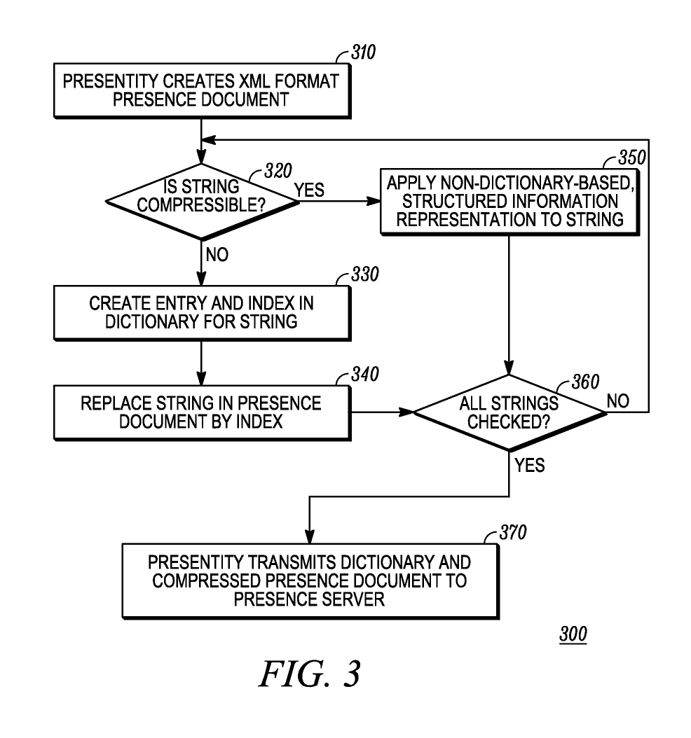

FIG. 3 is a flowchart of a method of compressing presence information in accordance with some embodiments.

At 310, the presentity creates a presence document in XML format. At 320, the presentity considers a first string within the presence document.

If the first string is uncompressible, then the method 300 proceeds to 330. At 330, the presentity creates a dictionary entry for the string. An index is also created, to accompany the dictionary entry. Then, at 340, the presentity replaces the string in the presence document, by substituting the index. At 360, method 300 will decide that all strings have not yet been checked, and return to decision box 320 for the next string in the presence document.

If, instead, at 320, the method finds that the first string is compressible, then method 300 proceeds to 350. At 350, a non-dictionary-based, structured information representation method is applied to the string. Then method 300 passes to decision 360.

When all the strings in the presence document have been checked and processed either as shown at 330 and 340, or as shown at 350, then decision 360 will result in the method passing to 370. At 370, the presentity transmits the presence document and the dictionary to the presence server, with the presence document having been compressed.

The method 300 of FIG. 3 provides a sequential review of each string in a presence document. The ‘first portion’ of the presence document comprises all strings identified at 320 as being uncompressible, and which are processed as shown at 330 and 340. The ‘second portion’ of the presence document comprises all the strings identified at 320 as being compressible, and which are processed as shown at 350.

FIGS. 2 and 3 have considered the actions by one presentity. However, a presence server in a wireless communication system will receive presence documents from multiple presentities. Those presence documents will need to be stored, and forwarded to multiple watchers.

In a wireless communication system with multiple presentities, each presentity may create a dictionary containing the indices and the corresponding strings for presence documents that it creates. The presentity then sends the initial PIDF presence document along with the dictionary to the presence server. We can refer to this first presentity as P1. The presence server stores P1's dictionary. A NOTIFY message from the presence server to a watcher contains P1's dictionary and P1's presence document. The watcher stores P1's dictionary locally. Similarly, a second presentity P2 sends an initial PIDF presence document along with its dictionary to the presence server. The server stores P2's dictionary. A NOTIFY message to the watcher provides P2's dictionary and P2's presence document. The watcher also stores P2's dictionary locally.

At this point, both the server and the watcher have the same set of dictionaries. Both the server and the watcher have P1 and P2's dictionaries. However, the presentities P1 and P2 have only one dictionary each—their own. This process continues for all presentities P1, P2, . . . Pi, where the watcher has subscribed to each of presentities P1, P2, . . . Pi.

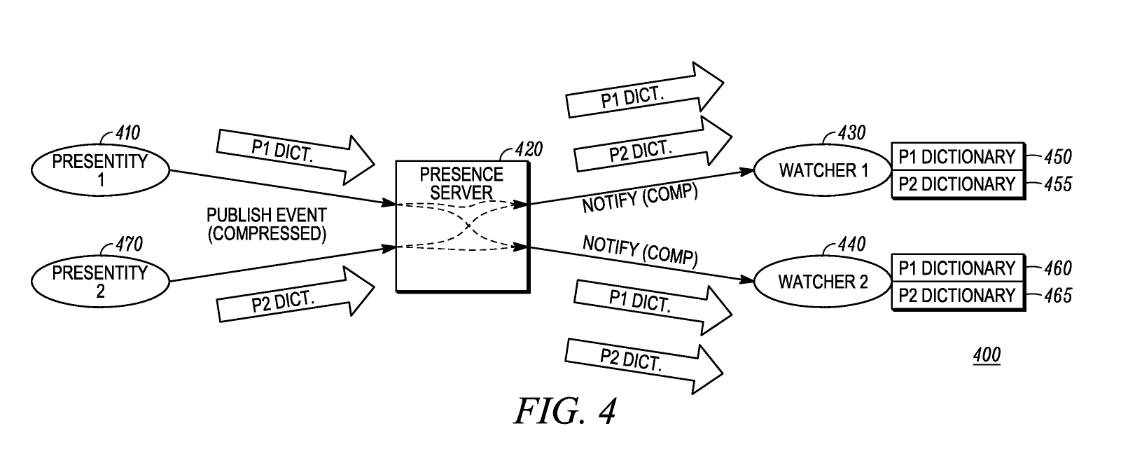

FIG. 4 shows an illustration of a communications system with two presentities in accordance with some embodiments.

A first presentity 410 provides a first dictionary P1 together with a first presence document, with the first dictionary P1 illustrated as ‘P1 DICT’ on FIG. 4. First dictionary P1 is compiled as shown in FIG. 2 or FIG. 3. First presentity 410 transmits first dictionary P1 and the first presence document to a presence server 420 with a PUBLISH message.

Presence server 420 does not need to decompress first dictionary P1. Instead, presence server 420 forwards the first dictionary P1 and the first presence document to each watcher that has subscribed to first presentity 410, as a NOTIFY message. In the case of FIG. 4, this means that presence server 420 forwards the first dictionary P1 and the first presence document to both a first watcher 430 and a second watcher 440. As shown at the right edge of FIG. 4, first watcher 430 stores first dictionary P1 as shown at reference 450. Second watcher 440 stores first dictionary P1 as shown at reference 460. All watchers that have subscribed to first presentity 410 will receive and store a single copy of first dictionary P1.

A second presentity 470 provides a second dictionary P2 together with a second presence document, with the second dictionary P2 illustrated as ‘P2 DICT’ on FIG. 4. Second dictionary P2 is compiled as shown in FIG. 2 or FIG. 3. Second presentity 470 transmits second dictionary P2 and the second presence document to the presence server 420 with a PUBLISH message.

Presence server 420 does not need to decompress second dictionary P2. Instead, presence server 420 forwards the second dictionary P2 and the second presence document to each watcher that has subscribed to second presentity 470, as a NOTIFY message. In the case of FIG. 4, this means that presence server 420 forwards the second dictionary P2 and the second presence document to both first watcher 430 and second watcher 440. As shown at the right edge of FIG. 4, first watcher 430 stores second dictionary P2 as shown at reference 455. Second watcher 440 stores second dictionary P2 as shown at reference 465. All watchers that have subscribed to second presentity 470 will receive and store a single copy of second dictionary P2.

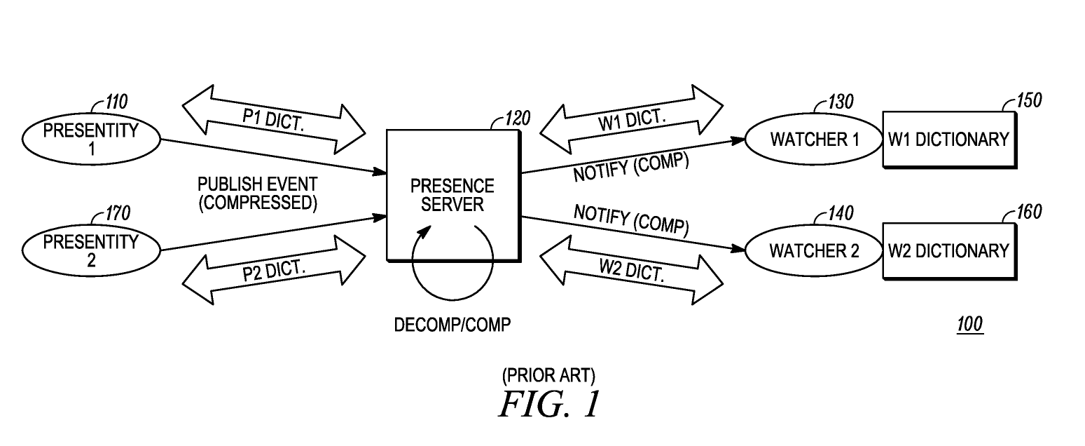

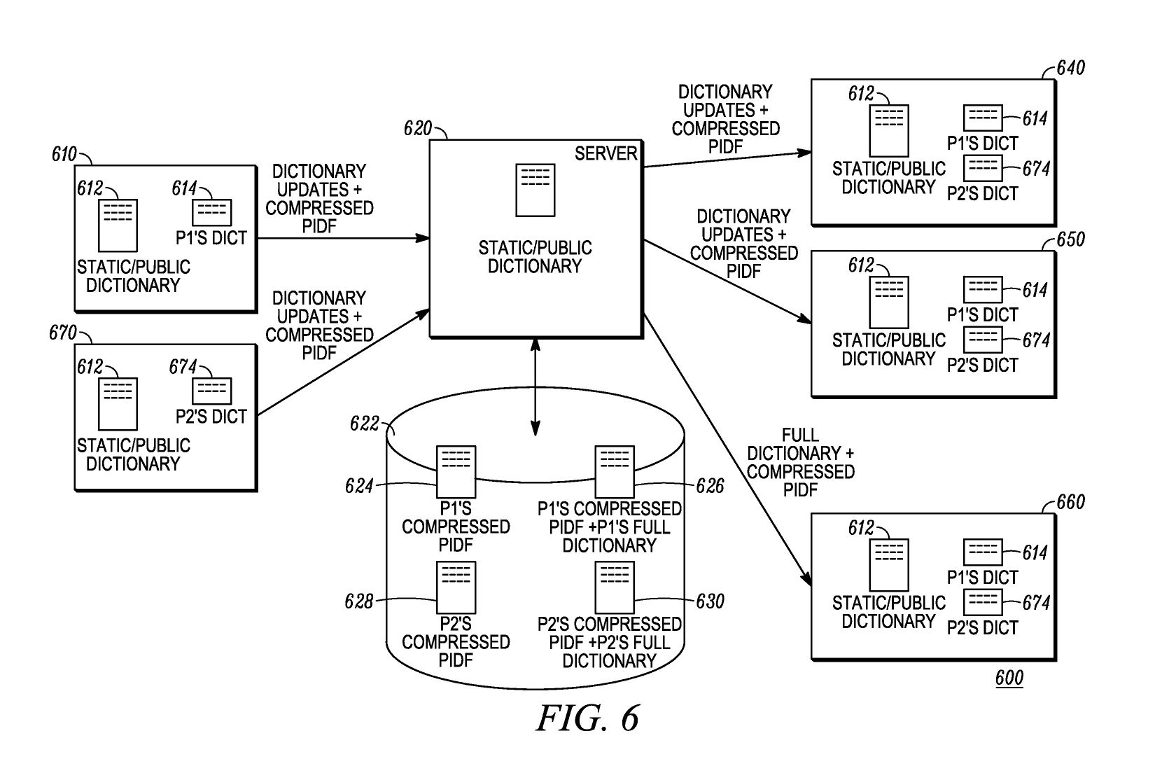

A comparison of FIGS. 1 and 4 shows several differences. Presence server 420 does not decompress each dictionary P1, P2 that is provided to it by a presentity 410, 470. Presence server 420 forwards each dictionary P1, P2 that it receives from any presentity 410, 470 to each watcher 430, 440. So presence server 420 does not need to create and forward a single large dictionary appropriate to each watcher. Processing by the watchers 430, 440 only involves receiving a single dictionary of the size of P1 or P2, rather than receiving the bespoke dictionary W1 or W2 of FIG. 1. The communication system of FIG. 4 also has different storage requirements than those for the system of FIG. 1. This is explained more fully with regard to FIG. 6.

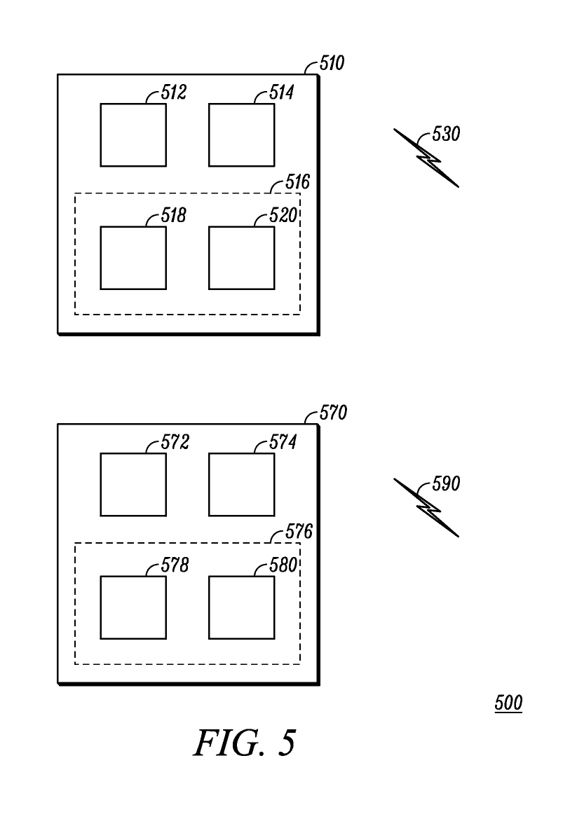

FIG. 5 illustrates the arrangement of a presentity and the storage of dictionaries in accordance with some embodiments.

More particularly, FIG. 5 illustrates a portion 500 of a communication system comprising a first user terminal 510 associated with a first presentity (which first presentity and first user terminal are interchangeably referred to as reference 510), which corresponds to presentity 410 of FIG. 4. A source of presence information 512, implemented by the first user terminal, may generate a presence document, under the control of a processor 514 of the first user terminal Within a memory device 516 of the first user terminal, first presentity 510 holds a static dictionary 518 and a first dynamic dictionary 520. First dynamic dictionary 520 corresponds to first dictionary P1 discussed in relation to FIG. 4. First presentity 510, that is, the first user terminal, may link over wireless link 530 to a presence server such as presence server 420 of FIG. 4.

FIG. 5 shows a second user terminal 570 associated with a second presentity (which second presentity and second user terminal are interchangeably referred to as reference 570), which corresponds to presentity 470 in FIG. 4. A source of presence information 572, implemented by the second user terminal, may generate a presence document, under the control of a processor 574 of the second user terminal Within a memory device 576 of the second user terminal, second presentity 570 holds a static dictionary 578 and a second dynamic dictionary 580. Second dynamic dictionary 580 corresponds to second dictionary P2 discussed in relation to FIG. 4. Second presentity 570, that is, the second user terminal, may link over wireless link 590 to a presence server such as presence server 420 of FIG. 4. However, static dictionary 578 may, in some embodiments, correspond exactly to static dictionary 518 held by first presentity 510. In this case, the first and second presentities 510, 570 of FIG. 5 each hold a different dynamic dictionary, but the same static dictionary. As used herein, the presentities, sources of presence information, and watchers are implemented by corresponding user terminals, such as user terminals 510 and 570, and more particularly by the processors of the user terminals based on data and instructions maintained in the corresponding memory devices of the user terminals, and functions performed herein by the presentities, sources of presence information, and watchers are performed by the corresponding user terminals, and more particularly by the processors of the user terminals based on data and instructions maintained in the corresponding memory devices. A user terminal may be, but is not limited to, a wireless mobile device, for example, a cellular telephone, a radio telephone, a personal digital assistant (PDA) with radio frequency (RF) capabilities, or a wireless modem that provides RF access to digital terminal equipment (DTE) such as a laptop computer, or may be a wireline device, such as but not limited to a wireline telephone, a personal computer (PC), a laptop computer, or other digital terminal equipment (DTE) that may interface to a wireline network.

FIG. 6 shows a communication system 600 in accordance with some embodiments. Communication system 600 comprises a first presentity 610 and a second presentity 670. Both first presentity 610 and second presentity 670 transmit presence documents and dictionaries to a presence server 620. Illustrated within first presentity 610 are a static dictionary 612 and a first dynamic dictionary 614. Illustrated within second presentity 670 are a static dictionary 612 and a second dynamic dictionary 674.

A storage area 622 of presence server 620 may comprise a database. Storage area 622 is illustrated as holding a first compressed PIDF document 624 from first presentity 610, and a second compressed PIDF document 628 from second presentity 670. Storage area 622 is also illustrated as storing a third document 626, which comprises the first compressed PIDF document from first presentity 610 and the first dynamic dictionary 614, held as a full dictionary for first presentity 610. Storage area 622 is also illustrated as storing a fourth document 630, which comprises the second compressed PIDF document 628 from second presentity 670 and the second dynamic dictionary 674, which is held as a full dictionary for second presentity 670.

A first watcher 640 holds static dictionary 612, first dynamic dictionary 614 and second dynamic dictionary 674. A second watcher 650 also holds static dictionary 612, first dynamic dictionary 614 and second dynamic dictionary 674. First watcher 640 and second watcher 650 are watchers who have each already received first dynamic dictionary 614 and second dynamic dictionary 674, so can be considered to be ‘pre-existing’ subscribers. From the time point illustrated in FIG. 6 onwards, first watcher 640 and second watcher 650 now only need to receive any updates to the first dynamic dictionary 614 and the second dynamic dictionary 674.

A third watcher 650 is a new subscriber, i.e. not a pre-existing subscriber. Third watcher 660 subscribed to first presentity 610 and second presentity 670, sometime after first watcher 640 and second watcher 640 have already received their dictionaries, and after first presentity 610 and second presentity 670 have each issued at least one dictionary update. Third watcher 660 does finally hold each of static dictionary 612, first dynamic dictionary 614 and second dynamic dictionary 674, in the situation shown in FIG. 6. However, presence server 620 has supplied first dynamic dictionary 614 and second dynamic dictionary 674 to third watcher 660 by forwarding the third document 626 and fourth document 630 that presence server 620 holds. Thus third watcher 660 has received the full copy of each of first dynamic dictionary 614 and second dynamic dictionary 674, with all cumulative dictionary updates included in each. Third watcher 660 is thereby brought up to date, with one NOTIFY message from presence server 620, as soon as third watcher 660 joins as a new watcher. The options for generating updates were described with reference to FIG. 2.

In FIG. 6, there may be many more presentities that send presence documents to presence server 620. Presence server 620 maintains two different copies of the PIDF-format presence document for every presentity that publishes presence documents. One copy is the compressed PIDF, with dictionary updates, if any. The second copy is the compressed PIDF, together with the full dictionary from the presentity concerned. Presence server will send this second copy in a NOTIFY message sent to any new subscriber, as was illustrated for the example of third watcher 660 in FIG. 6.

Summarizing the various embodiments of FIGS. 2-6, a method to compress XML presence documents with a smart, hybrid combination of ASN-1 and dictionary-based compression has been described. Dictionary entries can be signaled through presence bodies, by making use of standardized XML semantics and syntax, i.e. the standard XML entity declaration mechanism. Dictionary entries are distributed across various participating entities in a way that may reduce dictionary management overheads, with dictionaries being shared by various presentities. A presence server may exploit the commonalties in data being sent to multiple watchers, in order to achieve better compression and lower memory usage on the server. Where a public dictionary is available, this may also be used, thereby reducing the number of dictionary entries that need to be created in a dynamic dictionary. A presence server may hold separate copies of public dictionaries, ‘non-public’ presentity-specific dictionaries, and ‘non-public’ document-specific dictionaries. One advantage that may be achieved is lower CPU utilization for compression, by reducing the dictionary sizes, which is made possible by distributing the dictionaries across multiple presence bodies.

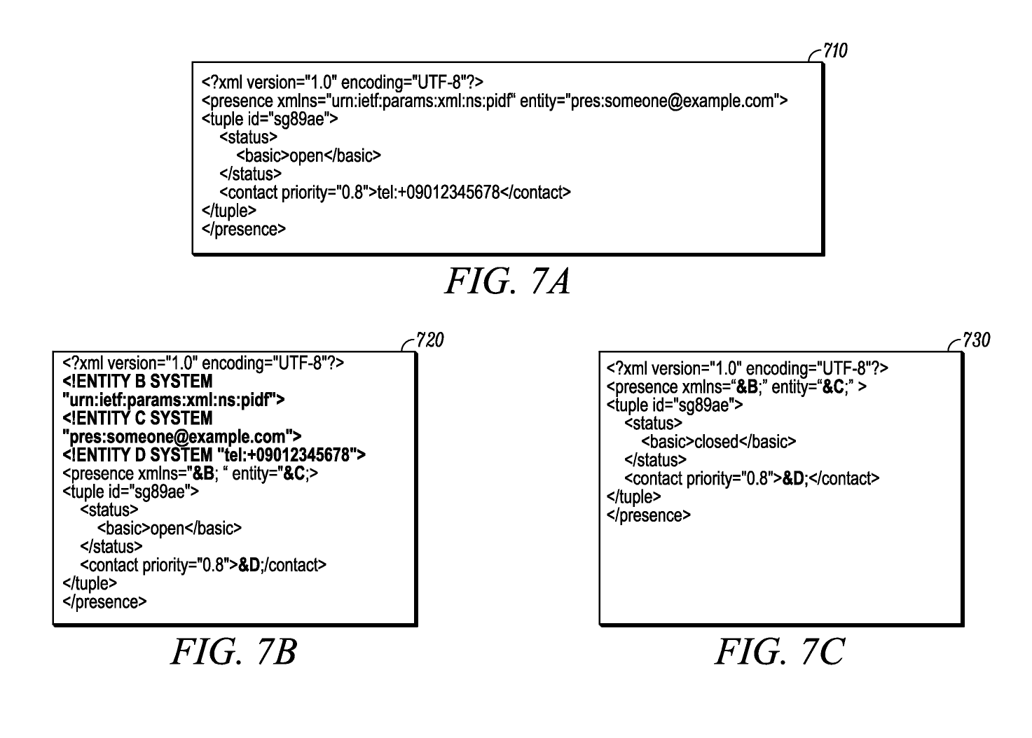

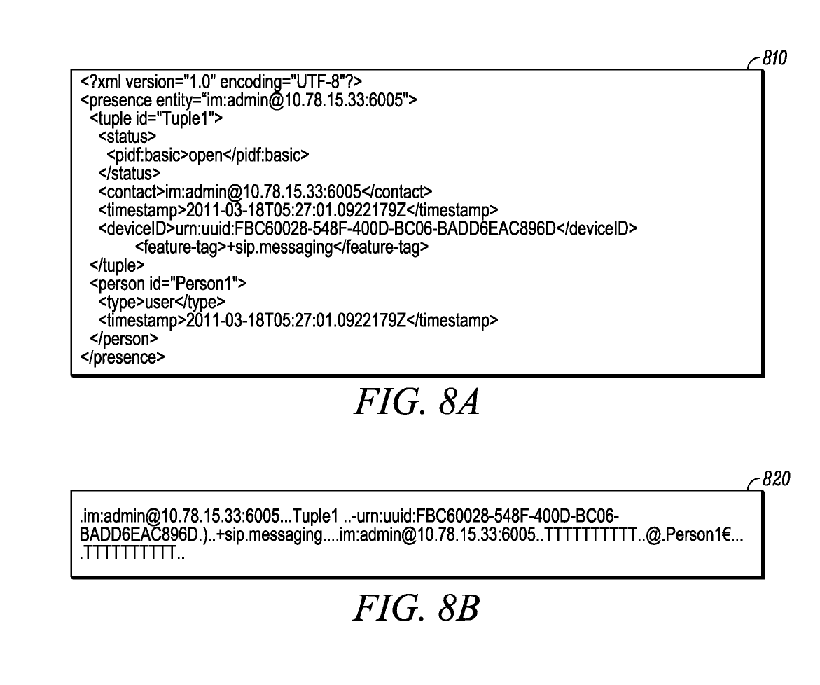

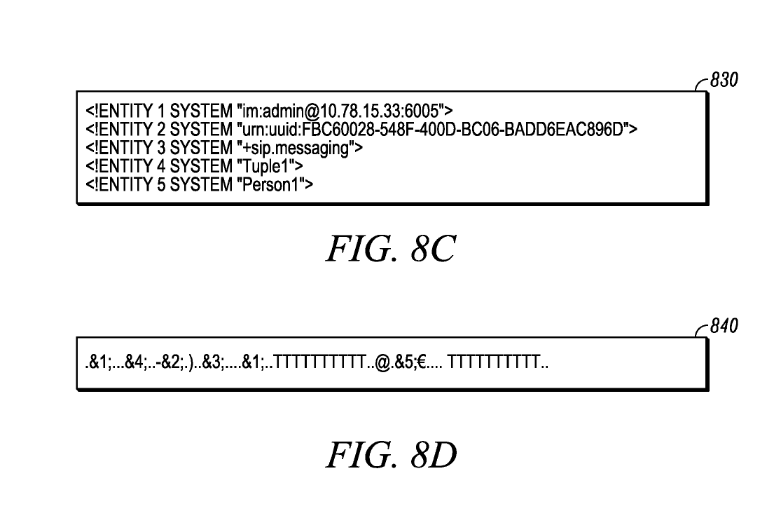

FIGS. 7 (that is, FIGS. 7A, 7B, and 7C) and 8 (that is, FIGS. 8A, 8B, 8C, and 8D) show documents that may be created, in a non-limiting example of an application of the method of some embodiments.

FIGS. 7A, 7B and 7C illustrate dictionary-only compression. FIG. 7A illustrates an uncompressed document 710 from a presentity.

FIG. 7B illustrates a document 720, which is the same document as FIG. 7A, but with entities B, C and D defined within it. FIG. 7B shows an initial document for transmission, with three dictionary entries. In lines 2-6 of document 720, the dictionary indices ‘&B’, ‘&C’ and ‘&D’ are defined. Each of ‘&B’, ‘&C’ and ‘&D’ is defined as being equal to one of the dynamic character strings that can be seen in document 710 of FIG. 7A. In lines 7 and 12 of document 720 in FIG. 7B, the dictionary indices have been used as ‘&B’, ‘&C’ and ‘&D’, to replace the respective dynamic strings that they represent. Dictionary indices ‘&B’, ‘&C’ and ‘&D’ have been placed in lines 7 and 12 of document 730 as ASN-1 user-defined texts. Lines 2-6 of document 720 define indices and the corresponding dynamic strings of a dictionary for the presentity that produced document 710.

FIG. 7C shows a subsequent document 730. Document 730 may be produced by the same presentity as document 720, sometime later. However, document 730 includes the dictionary entries ‘&B’, ‘&C’ and ‘&D’, placed as ASN-1 user-defined texts, to replace dynamic strings. However, document 730 does not need to incorporate the strings that each of ‘&B’, ‘&C’ and ‘&D’ defines. These definitions were already transmitted to the presence server and to any watchers in earlier document 720.

When any or all of dictionary indices ‘&B’, ‘&C’ and ‘&D’ have already been defined in a static dictionary that is available to the presentity that produced document 710, then those indices, as defined in the static dictionary, can be used straight away. There is then no need to define them as shown in lines 2-6 of document 720.

FIGS. 8A, 8B, 8C and 8D illustrate non-limiting examples of documents that may be produced by some embodiments. The size of each document in FIGS. 8A-8D provides a numerical illustration of savings that may be achieved.

FIG. 8A shows document 810. Document 810 is an entirely uncompressed text, which amounts to 471 bytes of data.

FIG. 8B shows document 820, which is the ASN-1 encoded text. Document 820 amounts to 208 bytes of data, but does not include the dictionary.

FIG. 8C shows the dictionary created by the same presentity as documents 810 and 820. ASN-1 also allows encoding of time with 21 bits for a date, 38 bites for a time and 1 bit for Z. So a time and date consumes, in total 60 bits or 10 bytes (in base 64 format).

FIG. 8D shows the ASN-1 and Dictionary Encoded text, which is a total of 68 bytes. A presentity may send much less data than with known systems, particularly when a dictionary from that presentity has already been provided to a watcher, and only a small dictionary update is necessary with a newly produced presence document.

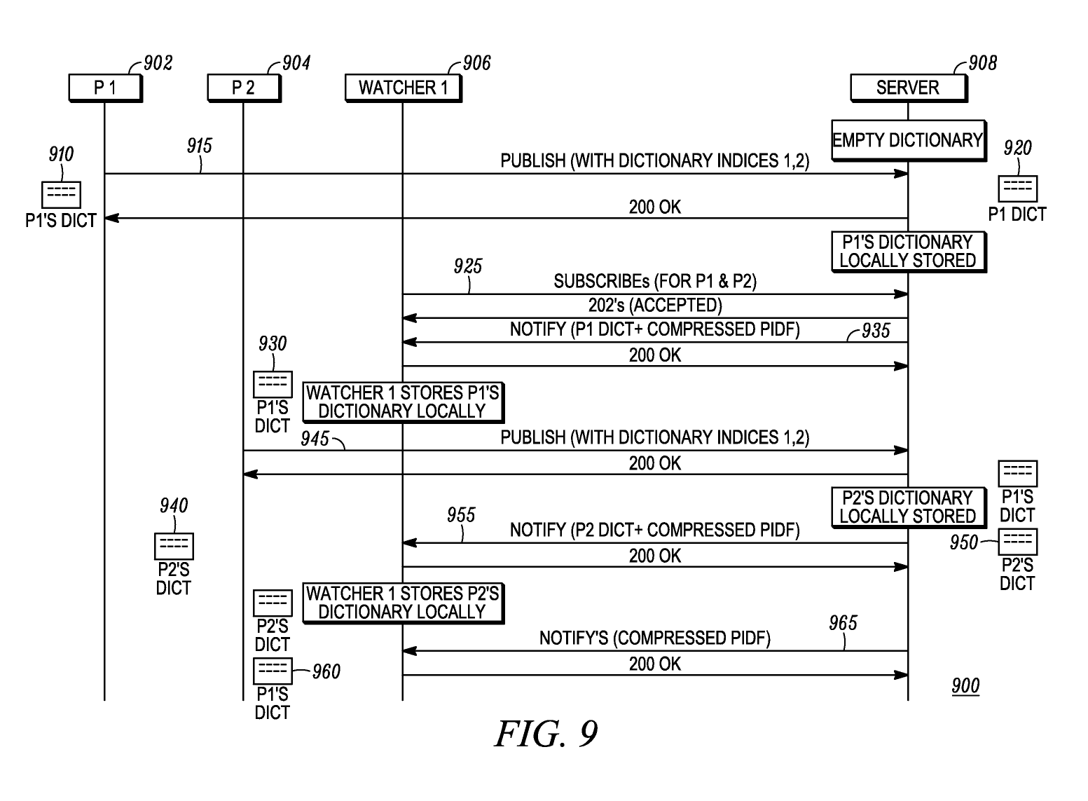

FIG. 9 shows a message sequence chart 900 for signaling employed by some embodiments.

A presentity P1 shown as reference 902 provides a first dictionary 910 with a PUBLISH message 915. Once published, first dictionary 910 is stored by a presence server 908, shown as reference 920. A watcher 1 shown as reference 906 subscribes 925 to first dictionary 910, and also to a second dictionary 940 from a second presentity P2 shown with reference 904.

Presence server 908 can forward first dictionary 910 and the compressed presence document from Presentity P1 to Watcher 1, with a NOTIFY message 935. Watcher 1 stores first dictionary 910 as shown at 930.

Presentity P2, shown with reference 904, then provides a second dictionary 940 with a PUBLISH message 945. Once published, second dictionary 940 is stored by presence server 908, shown as reference 950.

Presence server 908 can forward second dictionary 940 and the compressed presence document from Presentity P2 to Watcher 1, with the NOTIFY message 955. Watcher 1 stores second dictionary 940 as shown at 960.

Subsequently, presence server 908 needs only to send to Watcher 1 a compressed PIDF presence document from either Presentity P1 or Presentity P2, when either Presentity P1 or Presentity P2 provides a new presence document that does not have dictionary updates. The compressed PIDF presence document is sent as a NOTIFY message, as shown for example at 965. If dictionary updates are needed, then these would also be sent with the compressed PIDF presence document shown at 965.

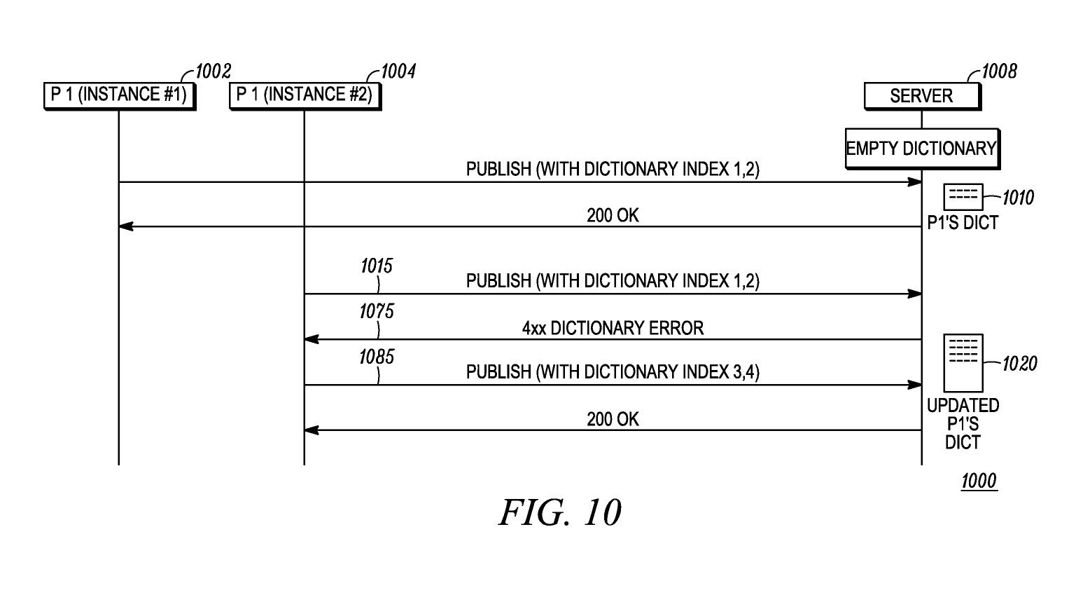

FIG. 10 uses similar numbering to that used in FIG. 9 for corresponding elements. FIG. 10 shows a message sequence chart 1000 for signaling employed by some embodiments. In particular, FIG. 10 illustrates message flows when a publisher, such as a first instance of Presentity P1, shown as reference 1002, logs in from two places and publishes simultaneously. A presence server 1008 detects that a second instance 1004 of Presentity P1 is trying to use the same dictionary indices as the first instance 1002 of Presentity P1, when the second instance 1004 of Presentity P1 sends a PUBLISH message 1015.

Presence server 1008 rejects the PUBLISH message 1015 with a ‘4xx’ response at 1075. The response carries the correct range of indices to use. Presentity P1 then sends a PUBLISH message 1085 with the correct indices.

The situation illustrated in FIG. 10 may, for example, occur with dynamic indexes. If the same user (presentity) logs on from two different devices, then the presence server detects this situation. So if a user logs in to the presence server from a cell phone and also at the same time from a desktop PC, for example, then the presence server will only accept the first dictionary provided by the user. Each dictionary is ‘per user’, so one user supplies one dictionary. Watchers, too, only subscribe to watch a given user (presentity). So a presence sever will not accept and forward to a watcher two different dictionaries from the same user, when that user is logged on to two different devices.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. In a wireless communications system, a method of compressing presence information in a presence document for wireless transmission, the presence document being in XML format, the method comprising a presentity of the wireless communications system:
applying dictionary-based compression to a first portion of the presence document, the first portion of the presence document comprising at least one item of uncompressible information; and
applying a non-dictionary-based, structured information representation to a second portion of the presence document.

2. The method of claim 1, wherein the at least one item of uncompressible information comprises an unenumerated character string.

3. The method of claim 1, wherein the at least one item of uncompressible information comprises a dynamic entity.

4. The method of claim 3, wherein the at least one item of uncompressible information comprises one or more of: user names; URLs; device names; dates and IP addresses.

5. The method of claim 1, wherein:
the non-dictionary-based, structured information representation is ASN-1 encoding.

6. The method of claim 1, wherein:
the second portion of the presence document comprises one or more of tags, enumerated strings, and XML fields.

7. The method of claim 1, further comprising the presentity:
creating a dictionary of indices, wherein each index corresponds to an item of uncompressible information in the first portion of the presence document; and
replacing an item of uncompressible information in the first portion of the presence document by the corresponding index from the dictionary of indices.

8. The method of claim 7, further comprising the presentity:
creating an updated entry for the dictionary of indices, the updated entry comprising at least one of:
a new index, corresponding to a new item of uncompressible information in the first portion of the presence document or in a new presence document; or
an update of an existing index in the dictionary of indices; and
transmitting the updated entry to the receiving party.

9. The method of claim 7, further comprising the presentity:
transmitting the dictionary of indices to a receiving party; and
waiting for an acknowledgment from the receiving party that the dictionary of indices has been received, before replacing the item of uncompressible information in the first portion of the presence document by the corresponding index from the dictionary of indices.

10. The method of claim 8, further comprising the presentity:
transmitting the updated entry for the dictionary of indices to the receiving party; and
waiting for an acknowledgment from the receiving party that the updated entry has been received, before using the new index or the update of an existing index, to replace an item of uncompressible information in the first portion of the presence document.

11. The method of claim 1, further comprising the presence document being in the Presence Information Data Format of XML; and
the presentity using the entity reference mechanism of the XML standard to indicate dictionary indices in the presence document,
whereby the dictionary indices will be transmitted within the presence document.

12. In a wireless communications system, a method of transmitting a presence document, the presence document being in XML format, the method comprising a presentity of the wireless communications system:
identifying a dynamic string in the presence document;
creating an entry in a dictionary for the dynamic string, the entry comprising the dynamic string and a corresponding index;
replacing the dynamic string in the presence document by the corresponding index;
applying a non-dictionary-based, structured information representation to one or more of tags and enumerated XML fields in the presence document; and
transmitting the presence document and the dictionary to a server of the wireless communication system.

13. The method of claim 12, wherein:
the presence document is in the Presence Information Data Format of XML; and
further comprising:
transmitting the presence document to the server of the wireless communication system using UDP protocol, DTLS protocol, TCP protocol, TLS protocol, or HTTP protocol.

14. In a wireless communication system, a method of transmitting XML format presence documents, the method comprising:
a first presentity transmitting a first presence document to a server of the wireless communication system, the first presence document comprising a first dictionary and a first compressed XML format presence document, the first dictionary comprising indices for uncompressible information in the first presence document, each index being stored in the first dictionary with a corresponding item of uncompressible information;
a second presentity transmitting a second presence document to the server of the wireless communication system, the second presence document comprising a second dictionary and a second compressed XML format presence document, the second dictionary comprising indices for uncompressible information in the second presence document, each index being stored in the second dictionary with a corresponding item of uncompressible information;
the server of the wireless communication system:
transmitting a first notify message to each watcher of the first presentity, the first notify message comprising the first dictionary and the first compressed XML format presence document;
transmitting a second notify message to each watcher of the second presentity, the second notify message comprising the second dictionary and the second compressed XML format presence document;
whereby a watcher of both the first presentity and the second presentity holds both the first dictionary and the second dictionary.

15. The method of claim 14, further comprising:
the first presentity transmitting the first presence document to the server of the wireless communication system as a first publish message; and
the second presentity transmitting the second presence document to the server of the wireless communication system as a second publish message.

16. The method of claim 14, further comprising the server of the wireless communication system storing both the first dictionary and the second dictionary.

17. The method of claim 15, further comprising:
the first presentity transmitting a third publish message to the server of the wireless communication system, the third publish message comprising an update to the first dictionary and a third compressed presence document;
the second presentity transmitting a fourth publish message to the server of the wireless communication system, the fourth publish message comprising an update to the second dictionary and a fourth compressed presence document;
the server of the wireless communication system transmitting:
a third notify message to each watcher of the first presentity, the third notify message comprising the update to the first dictionary and the third compressed presence document;
a fourth notify message to each watcher of the second presentity, the fourth notify message comprising the update to the second dictionary and the fourth compressed presence document;
whereby a watcher of both the first presentity and the second presentity holds both the update to the first dictionary and the update to the second dictionary.

18. The method of claim 17, further comprising the server of the wireless communication system:
creating a first full dictionary, the first full dictionary comprising the first dictionary and the update to the first dictionary;
storing the third compressed presence document, the update to the first dictionary and the first full dictionary.

19. The method of claim 18, further comprising:
when the server of the wireless communication system receives a request from a new watcher for presence information about the first presentity, the server sending a notify message to the new watcher comprising the third compressed presence document and the first full dictionary.

20. The method of claim 18, further comprising the server of the wireless communication system:
creating a second full dictionary, the second full dictionary comprising the second dictionary and the update to the second dictionary;
storing the fourth compressed presence document, the update to the second dictionary and the second full dictionary; and
when the server of the wireless communication system receives a request from a second new watcher for presence information about the second presentity, the server sending a notify message to the second new watcher comprising the fourth compressed presence document and the second full dictionary.

21. The method of claim 20, further comprising a watcher of both the first presentity and the second presentity holding, separately, both the update to the first dictionary and the update to the second dictionary.

22. The method of claim 14, further comprising:
the first presentity, the second presentity, the first watcher, the second watcher and the server each holding a copy of a separate static dictionary that is publicly available.

23. A user terminal associated with a presentity, the user terminal comprising:
a processor configured to:
generate a presence document in XML format, for transmission in a wireless communication system;
identify a dynamic string in the presence document;
create an entry in a dictionary for the dynamic string, the entry comprising the dynamic string and a corresponding index;
replace the dynamic string in the presence document by the corresponding index;
apply a non-dictionary-based, structured information representation to one or more of tags and enumerated XML fields in the presence document; and
transmit the presence document and the dictionary to a server of the wireless communication system.
